(19) United States
(12) Patent Application Publication
(10) Pub. No.: US 2009/0116962 A1
(43) Pub. Date: May 7, 2009

(54) SENSORISED BLADE JOINT

(75) Inventors: Bent Herso Pedersen, Sarriguren (ES); Ion Arocena De La Rua, Sarriguren (ES); Ruben Rodriguez Sola, Sarriguren (ES); Eneko Sanz Pascual, Sarriguren (ES); Hely Ricardo Savii, Sarriguren (ES)

Correspondence Address: LADAS & PARRY LLP, 26 WEST 61ST STREET, NEW YORK, NY, 10023, US

(73) Assignee: GAMESA INNOVATION & TECHNOLOGY, S.L.

(21) Appl. No.: 12/199,816

(22) Filed: Aug. 28, 2008

(30) Foreign Application Priority Data
Sep. 14, 2007 (ES) 200702442

(51) Int. Cl. F03D 7/00

(52) U.S. Cl. 416/31; 416/61

(57) ABSTRACT

Wind turbine blade subdivided transversely into two or more sections made up of a number of sensors, preferably load cells and ultrasound sensors, assembled into the mechanical joining elements between blade sections and characterised in that their measurements allow the loads to be reduced and the forces to be controlled during the entire life of the blade. They also allow damages to be detected (stopping the machine if necessary) and an optimised design for real loads.

### FIELD OF THE INVENTION

The invention consists of sensors in the blade joining points for the purpose of permanently monitoring these points. The measurements are used to complement the control systems \textcircled{1} reducing the loads and controlling the forces throughout the life of the blade, \textcircled{2} detecting damages and stopping the machine if necessary \textcircled{3} and obtaining an optimised design for real loads.

This system is applicable to any mechanical joining system with fastening components and is especially applicable to a wind turbine blade made up of several sections.

### BACKGROUND OF THE INVENTION

The blade that will be sensorised is a transversely subdivided blade, referred to in patent P200500740 whose applicant is the holder.

On the other hand, the use of sensors located in wind power components is mentioned in document WO 2005/010358 which includes a wind turbine with a sensorised main shaft whose control reduces the effects of the loads.

Sensorisation is applied in order to understand the forces caused by the rotor in the main shaft and to therefore regulate the pitch or variable angle of the wind turbine blades.

Document WO 01/33075 describes sensorised blades that control the pitch or rotation of the blades, keeping the mechanical loads under certain working limits.

The same applicant of this invention holds patent P 200700444 which includes a sensorised gearbox that has a number of sensors assembled in a set of fixed parts, measuring the loads in the rotating shaft and the axial and radial forces derived from the operation of the wind turbine.

None of the patents mentioned sensorise the joint of a longitudinal structure that is internal, resistant and equipped with connection means at its end sections.

### DESCRIPTION OF THE INVENTION

The object of the invention is to have sensors in a transversely subdivided blade to measure the forces transmitted through the transverse joint of the blade.

The invention also aims to detect damage in the joining elements which results in the stopping of the machine (if necessary).

Another purpose of the invention is to obtain a precise measurement of the loads experienced by the blade for the control system and its management for different operating modes for the pitch and rotation control, in order to reduce the loads in the wind turbine.

Another object of the invention is the experimental determination of the load range supported by the joining elements; to experimentally validate the design hypothesis and to allow the number or design of the joining elements to be optimised.

Yet another object of the invention is the determination of the number of sensors and the places where they are positioned to obtain the axial forces of the joint pin, instantly and simultaneously, managing these data at all times.

Finally, the invention aims to select the type of sensor that is the most suitable with respect to ultrasound sensors and load cells.

From all the information described above, one can see that the advantages provided by the sensors referred to in the invention are:
Load reduction and weight reduction.
Optimisation and reduction of energy costs.
Avoids preventative maintenance.
Reduction of catastrophic failure.
Knowledge of the real loads in the blade joint.
Adjusted design hypotheses based on real loads.
Design optimised for real loads.
Decrease in the probability of failure of the blade and its joint.

### BRIEF DESCRIPTION OF THE FIGURES

FIG. 1 is a view of the end of a blade section showing the connection means.

FIG. 2 is a view of the blade joined by means of the connection bolts.

FIG. 3 shows certain details of a metal joint insert, its assembly with the composite material in the blade laminate and the assembly between metal inserts by means of joint pins.

FIG. 4 is a general view of a blade divided into two parts, with the transverse parts attached and with the controlled transmission system.

FIG. 5 shows the detail of an ultrasound sensor in the pin.

FIG. 6 shows the detail of a load cell in the pin.

FIG. 7 shows the detail of a load cell between the front faces of two opposite inserts.

### DESCRIPTION OF THE PREFERRED INSTALLATION

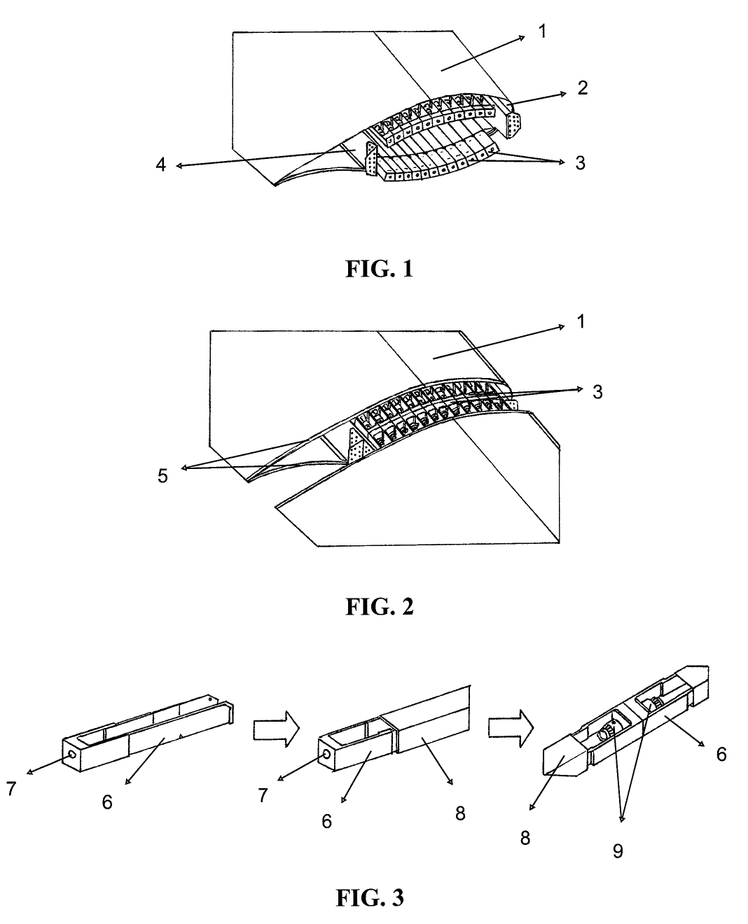

In FIG. 1, one can see part of a transversely subdivided blade (1) which shows its internal longitudinal structure (2) and that it is equipped with connection means (3) in its end sections. These connection means (3) are integrated in the structurally resistant part corresponding to the beam (4). When two end sections are joined, they give continuity to the blade (1), leaving only the connection means (3) without shell covering (5). These spaces are later covered with a fairing (5b) levelling the outer surface of the blade (1).

FIG. 3 shows the successive steps to prepare the connection means. First the metal insert (6) is prepared that has an axial drill (7) facing another insert in one of its ends. Later the metal insert (6) is shown joined, by adhesive, to a machined housing in the beam or resistant internal longitudinal structure (8). Finally, two metal inserts (6) are depicted with their axial drills (7) facing to receive pins and nuts (9) that make up the joining points. The aforementioned joint pins (9) work by traction.

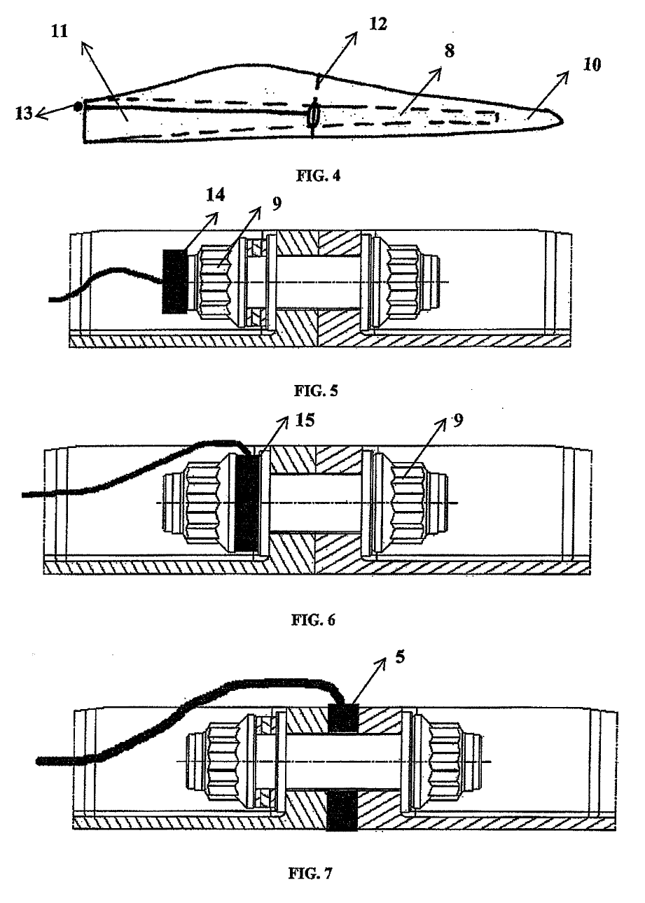

All the induced loads in the blade tip modules (10) are transmitted through the transverse subdivision (12) of the blade (1). This subdivision is made up of a small number of joining elements (3) so that the load ends up passing only through the joint pins (9). In this way one may obtain the exact total load that goes through the subdivision and may get an excellent estimator of the load transmitted by the blade to the wind turbine. As shown in FIG. 4, monitoring the joining points corresponding to the transverse subdivision (12) with different sensors, the measurements of the sensors can be sent up to the root of the blade (11) using the inside of the beam (8). Finally, the measurements will arrive at the control point (12) in the hub (not shown in the figure).

An ultrasound sensor (14) is used in FIG. 5; it sends an impulse that bounces off the end of the pin (9). The sensor measures the time that passes between the emission and reception of the impulse and transforms it into a preload measurement of the bolt that is sent to the control system (12). The ultrasound sensor (14) is at the end of the bolt (9) so that its signal can move lengthwise without any difficulty.

A load cell (15) is used in FIG. 6; it consists of a metal washer from which its strain is measured. Later, the measurement of the load is transformed to that which the bolt is subject to and the result is sent to the control system (12). The location of the sensor (15) is such that it is easy to replace in case of damage.

In a second installation shown in FIG. 7, the load cell (15) is between the two inserts to be assembled.

1. Sensorised blade joint uses a series of sensors to control the load of the bolts during the life of the blade, characterised in that:
a. the sensors are available in at least one the multiple connection means in the transverse joint section
b. the signals measured by the sensors are transmitted to a control system that may or may not be located in the blade that controls the forces exerted on the joint
c. the signals transmitted to the control system are used to detect possible damages in the connections
d. the signals transmitted to the control system are used to control the loads transmitted to the wind turbine
e. the signals transmitted to the control system are used to store the load range, optimising the design with the real loads obtained.

2. Sensorised blade joint, according to claim 1, characterised in that the sensors include at least one ultrasound sensor available at the end of the joint pin aligned with the resistant material that forms the insert.

3. Sensorised blade joint, according to claim 1, characterised in that the sensors include at least one load cell located in a part near the pin or between the walls of the two facing inserts.

4. Sensorised blade joint, according to claim 1, characterised in that the control system is located in the hub away from the distortions produced by blade rotation acceleration.

5. Sensorised blade joint, according to claim 1, characterised in that the control system is supplied with the measurements of the sensors leading their signal through the inside of the beam which forms the blade.
